(19) United States
(12) Patent Application Publication
(10) Pub. No.: US 2026/0316726 A1
(43) Pub. Date: Oct. 15, 2026

(54) BRAKE CONTROL DEVICE, MECHANICAL BRAKE DEVICE, AND BRAKE CONTROL SYSTEM

(71) Applicant: MITSUBISHI ELECTRIC CORPORATION, Chiyoda-ku, Tokyo (JP)

(72) Inventors: Etsuji MATSUYAMA, Tokyo (JP); Ryohei TSUGOSHI, Tokyo (JP)

(73) Assignee: MITSUBISHI ELECTRIC CORPORATION, Chiyoda-ku, Tokyo (JP)

(21) Appl. No.: 19/491,530

(22) PCT Filed: Jun. 26, 2023
(86) PCT No.: PCT/JP2023/023455

§ 371 Date: Dec. 9, 2025

(51) Int. Cl. B60T 8/17; B60T 17/22

(52) U.S. Cl. CPC B60T 8/1705; B60T 17/221; B60T 17/228; B60T 2270/40

(57) ABSTRACT

A brake control device controls mechanical brake devices each including a force amplification mechanism, a pressing mechanism, and a transmission mechanism. The force amplification mechanism generates a braking force by urging a friction member onto a rotating body in accordance with a force of being pressed. The pressing mechanism presses the force amplification mechanism. The transmission mechanism presses the force amplification mechanism with the force pressed by the pressing mechanism in a state in which the transmission mechanism is in contact with the pressing mechanism and the force amplification mechanism. The brake control device includes a target braking force determiner, a target mechanical-braking force determiner, a brake controller, and a transmission controller. The transmission controller allows or suppresses the pressing of the force amplification mechanism by the transmission mechanism.

### TECHNICAL FIELD

The present disclosure relates to a brake control device, a mechanical brake device, and a brake control system.

### BACKGROUND ART

A typical railway vehicle includes mechanical brake devices that generate braking forces by urging friction members onto rotating bodies that rotate during running of the railway vehicle. Due to a failure of the mechanical brake devices or seizure between the rotating bodies and the friction members, the friction members may remain urged onto the rotating bodies even when a braking command is not input. This phenomenon is referred to as brake binding. When the railway vehicle accelerates while the brake binding is occurring, the friction member urged onto a wheel in the mechanical brake device experiencing the brake binding may generate heat, and deterioration of the friction member may progress.

A typical example of a technique for releasing the brake binding in the mechanical brake devices is disclosed in Patent Literature 1. A forced release device disclosed in Patent Literature 1 forcibly releases the brake binding by applying external force by hydraulic pressure to a brake shoe when the brake shoe and the wheel of the brake device are stuck.

### CITATION LIST

### Patent Literature

Patent Literature 1: Unexamined Japanese Patent Application Publication No. 2021-024508

### SUMMARY OF INVENTION

### Technical Problem

In order to release the brake binding using the forced release device disclosed in Patent Literature 1, a brake shoe having a complex structure to separate from the wheel upon receiving force from the forced release device is necessary. Furthermore, it is necessary to provide a forced release device for each mechanical brake device, resulting in a complex structure of the entire brake control system.

Under such circumstances, an objective of the present disclosure is to provide a brake control device, a mechanical brake device, and a brake control system that are capable of releasing brake binding with a simple configuration.

### Solution to Problem

To achieve the above objective, the brake control device according to the present disclosure controls mechanical brake devices each including a force amplification mechanism that generates a braking force by urging, in accordance with a force of being pressed, a friction member onto a rotating body that rotates during running of a railway vehicle, a pressing mechanism that presses the force amplification mechanism, and a transmission mechanism that is provided between the pressing mechanism and the force amplification mechanism and presses the force amplification mechanism with a force pressed by the pressing mechanism in a state in which the transmission mechanism is in contact with the pressing mechanism and the force amplification mechanism. The brake control device includes a target braking force determiner, a target mechanical-braking force determiner, a brake controller, and a transmission controller. The target braking force determiner determines a target braking force from a braking command that provides an instruction for deceleration of the railway vehicle. The target mechanical-braking force determiner determines, from the target braking force, target mechanical-braking forces that are each a target value of the braking force to be generated by the mechanical brake device. The brake controller controls a pressing mechanism in accordance with the target mechanical-braking forces. The transmission controller allows or suppresses pressing of the force amplification mechanisms by the transmission mechanisms.

### Advantageous Effects of Invention

The brake control device according to the present disclosure includes the transmission controller that allows or suppresses the pressing of the force amplification mechanisms by the transmission mechanisms with the force pressed by the pressing mechanisms in a state in which the transmission mechanisms are in contact with the pressing mechanisms and the force amplification mechanisms. The transmission mechanism is provided in the mechanical brake device. The brake control device according to the present disclosure does not need a brake shoe having a complex structure or a forced release device provided for each mechanical brake device, and can release the brake binding with a simple configuration by the transmission controller suppressing the pressing of the force amplification mechanism by the transmission mechanism to suppress urging by the friction member onto the rotating body.

### BRIEF DESCRIPTION OF DRAWINGS

FIG. 1 is a block diagram illustrating a brake control system according to Embodiment 1;

FIG. 2 is a block diagram illustrating a hardware configuration of the brake control device according to Embodiment 1;

FIG. 3 illustrates a structure of a mechanical brake device according to Embodiment 1;

FIG. 4 illustrates an exemplary movement of the mechanical brake device according to Embodiment 1;

FIG. 5 illustrates another exemplary movement of the mechanical brake device according to Embodiment 1;

FIG. 6 is a block diagram illustrating a brake control system according to Embodiment 2;

FIG. 7 is a flowchart of an example operation of a brake control process performed by a brake control device according to Embodiment 2;

FIG. 8 is a block diagram illustrating a brake control system according to Embodiment 3;

FIG. 9 is a flowchart of a yet another example operation of a brake control process performed by a brake control device according to Embodiment 3;

FIG. 10 is a block diagram illustrating a brake control device according to a modification of the embodiments; and

FIG. 11 is a block diagram illustrating a hardware configuration of the brake control device according to the modification of the embodiments.

### DESCRIPTION OF EMBODIMENTS

A brake control device, a mechanical brake device, and a brake control system according to some embodiments of the present disclosure are described in detail below with reference to the accompanying drawings. Components identical or corresponding to each other are provided with the same reference sign in the drawings.

### Embodiment 1

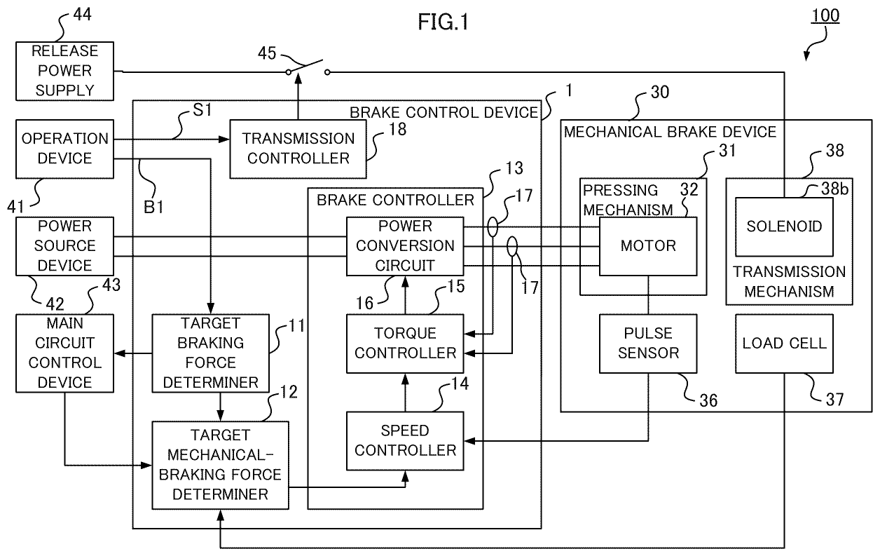

The following describes a brake control device according to Embodiment 1, focusing on an exemplary brake control device that is installed in a railway vehicle decelerating using an electric braking force and a mechanical braking force and that controls mechanical brake devices provided to the respective wheels. A brake control system 100 illustrated in FIG. 1 includes electrically operated mechanical brake devices 30 each of which generates a mechanical braking force using the torque of a motor 32, and a brake control device 1 that controls the mechanical brake devices 30. FIG. 1 illustrates only the components related to electrical control among the components of the mechanical brake device 30.

The brake control device 1 includes, for example, a target braking force determiner 11 that acquires a braking command B1 from an operation device 41 installed in a driver's cab and determines a target braking force from the braking command B1, and a target mechanical-braking force determiner 12 that determines a target mechanical-braking force from the target braking force. The target mechanical-braking force is a target value of the braking force to be generated by the mechanical brake devices 30.

The brake control device 1 also includes a brake controller 13 that controls the mechanical brake devices 30 based on the target mechanical-braking force, and a transmission controller 18 that acquires, from the operation device 41, a release command S1 that provides an instruction for release of brake binding, and controls, in accordance with the release command S1, transmission mechanisms 38 included in the mechanical brake devices 30.

Although FIG. 1 illustrates a single mechanical brake device 30 as a target to be controlled by the brake control device 1 in order to simplify the figure, the brake control device 1 actually controls multiple mechanical brake devices 30 provided to the respective wheels. Although FIG. 1 illustrates a single brake controller 13 included in the brake control device 1, the number of brake controllers 13 included in the brake control device 1 depends on the number of units for brake control.

The brake control device 1, upon acquiring the release command S1 that provides an instruction for release of brake binding in the mechanical brake devices 30, suppresses generation of braking force based on the torque of the motor 32 by controlling the transmission mechanisms 38. As a result, the brake binding in the mechanical brake devices 30 is released.

The following describes the individual components of the brake control device 1. The target braking force determiner 11 acquires the braking command B1 that provides an instruction for deceleration of the railway vehicle. The term “deceleration of the railway vehicle” refers not only to the slowing down of the railway vehicle but also the parking. In detail, the target braking force determiner 11 acquires, from the operation device 41, the braking command B1 that contains at least any of a normal braking command, an emergency braking command, and a safety braking command.

The normal braking command instructs the railway vehicle to decelerate in normal situations, and indicates a target deceleration of the railway vehicle. The emergency braking command instructs the railway vehicle to decelerate in emergency situations, and indicates a target emergency deceleration equal to or higher than the maximum value of the target deceleration indicated by the normal braking command. The safety braking command is applied when the railway vehicle fails to sufficiently decelerate despite of input of the normal or emergency braking command.

The operation device 41 includes a master controller that outputs a normal braking command indicating a target deceleration or an emergency braking command indicating a target emergency deceleration, a safety brake machine that outputs a safety braking command, and a release machine that outputs a release command S1 for release of brake binding in the mechanical brake device 30 to be targeted. The operation device 41 outputs, to the target braking force determiner 11, the braking command B1 that contains at least any of the normal braking command, the emergency braking command, and the safety braking command, and outputs the release command S1 to the transmission controller 18.

In response to a manipulation of a normal brake by an operator, the master controller outputs a normal braking command indicating a target deceleration associated with the notch corresponding to the manipulation of the operator. In response to a manipulation to activate an emergency brake by the operator, the master controller outputs an emergency braking command indicating a target emergency deceleration.

The safety brake machine generates a safety braking command at a high (H) level in response to a manipulation to activate a safety brake by the operator, and generates a safety braking command at a low (L) level in the absence of the manipulation to activate the safety brake by the operator. The safety brake machine outputs the generated safety braking command.

In response to a manipulation to release the brake binding in the mechanical brake device 30 by the operator, the release machine generates a release command S1 including an instruction to release the brake binding and the mechanical brake device 30 to be targeted, and transmits the release command S1 to the transmission controller 18. In the absence of the manipulation to release the brake binding in the mechanical brake device 30 by the operator, the release machine does not output the release command S1.

The target braking force determiner 11 determines a target braking force from the braking command B1 acquired from the operation device 41. The target braking force means the braking force needed to achieve the deceleration indicated by the braking command B1. When the target braking force determiner 11 acquires the braking command B1 that is the normal braking command or the emergency braking command, the target braking force determiner 11 determines a target braking force for the railway vehicle in accordance with the target deceleration indicated by the normal braking command or the target emergency deceleration indicated by the emergency braking command. Specifically, the target braking force determiner 11 acquires the weight of the vehicle bodies from load compensators, which are not illustrated, and determines a target braking force by multiplying the weight of the vehicle bodies by the target deceleration or the target emergency deceleration. When the target braking force determiner 11 acquires the safety braking command, the target braking force determiner 11 determines a target braking force by multiplying a predetermined safety deceleration by the weight of the vehicle bodies. The target braking force determiner 11 preliminarily retains information on the safety deceleration. The target braking force determiner 11 outputs the determined target braking force to the target mechanical-braking force determiner 12.

The target braking force determiner 11 determines a target electric braking force from the determined target braking force. The target electric braking force is a target value of the electric braking force to be caused through consumption of the electric power generated by main motors serving as electric generators. The main motor is fed with electric power and generates propulsion for the railway vehicle. The main motor serves as an electric generator during braking. The target braking force determiner 11 transmits the determined target electric braking force to the main circuit control device 43.

The main circuit control device 43 controls a main power conversion device that converts electric power fed from a current collector into electric power to be fed to the main motors and feeds the converted electric power to the main motors, or converts electric power fed from the main motors serving as electric generators into electric power to be fed to other railway vehicles and outputs the converted electric power to the current collector. During braking, the main circuit control device 43 controls the main power conversion device in accordance with the target electric braking force acquired from the target braking force determiner 11. Feeding and consuming the electric power fed from the main motors serving as electric generators in other railway vehicles leads to generation of an electric braking force. The main circuit control device 43 transmits a regeneration feedback, indicating the actual electric braking force, or the electric braking force actually generated, to the target mechanical-braking force determiner 12.

The target mechanical-braking force determiner 12 determines a target mechanical-braking force from the difference between the target braking force and the actual electric braking force indicated by the regeneration feedback. The target mechanical-braking force is a target value of the mechanical braking force to be generated by the mechanical brake devices 30. The target mechanical-braking force determiner 12 acquires the pressing force of each of the mechanical brake devices 30 from a load cell 37 included in the mechanical brake device 30, and determines an actual mechanical braking force, or the mechanical braking force actually generated. The target mechanical-braking force determiner 12 adjusts the value of the target mechanical-braking force through feedback control based on the actual mechanical braking force, and outputs the adjusted target mechanical-braking force to the brake controllers 13.

Each of the brake controllers 13 controls the electrically operated mechanical brake device 30. In detail, the brake controller 13 includes a speed controller 14 that determines a target torque from the target mechanical-braking force, a torque controller 15 that generates pulse width modulation (PWM) signals from the target torque and the actual torque of the motor 32 and outputs the PWM signals, and a power conversion circuit 16 that converts electric power fed from a power source device 42 into electric power to be fed to the motor 32 of the mechanical brake device 30.

The speed controller 14 acquires the target mechanical-braking force from the target mechanical-braking force determiner 12, and acquires the rotational speed of the motor 32 from a pulse sensor 36 included in the mechanical brake device 30. The speed controller 14 determines a target pressing force, or a target value of the pressing force, from the target mechanical-braking force. The speed controller 14 determines a target torque, or a target value of the torque of the motor 32, from the target pressing force and parameters of the mechanical brake device 30. The parameters of the mechanical brake device 30 are used to convert the pressing force into the torque of the motor 32. The speed controller 14 preliminarily retains information on the parameters of the mechanical brake device 30. The speed controller 14 acquires the rotational speed of the motor 32 from the pulse sensor 36, adjusts the target torque determined as described above to gradually increase the rotational speed of the motor 32, and outputs the adjusted target torque to the torque controller 15.

The torque controller 15 acquires the target torque of the motor 32 from the speed controller 14, and acquires, from current sensors 17, measured values of current output from the power conversion circuit 16. In detail, the torque controller 15 acquires a measured value of U-phase current and a measured value of V-phase current from the current sensors 17, and determines a value of W-phase current from the measured values of U-phase and V-phase current. The torque controller 15 then determines an actual torque of the motor 32 from the values of U-phase, V-phase, and W-phase current. The torque controller 15 generates PWM signals through feedback control based on the target torque and the actual torque. The torque controller 15 outputs the PWM signals to respective switching elements included in the power conversion circuit 16.

The power conversion circuit 16 includes the switching elements controlled by the PWM signals fed from the torque controller 15. The switching operation of the switching elements causes the power conversion circuit 16 to convert DC power fed from the power source device 42 into three-phase AC power and feed the three-phase AC power to the motor 32 of the mechanical brake device 30.

The power source device 42 converts electric power fed from the current collector, which is not illustrated, into electric power to be fed to the power conversion circuits 16, and outputs the converted electric power to the power conversion circuits 16. The power source device 42 includes an inverter that is fed with DC power from the current collector for acquiring electric power from a substation via a power supply line and that converts the DC power into AC power, and a rectifier circuit that rectifies the AC power into DC power.

The transmission controller 18 switches a relay 45 between on and off. The relay 45 electrically connects a solenoid 38b included in the transmission mechanism 38 of the mechanical brake device 30 and a release power supply 44. In Embodiment 1, the relay 45 is normally set to off. The transmission controller 18 maintains the relay 45 in the off state until the transmission controller 18 acquires the release command S1 that provides an instruction for release of brake binding in the mechanical brake devices 30.

When the transmission controller 18 acquires the release command S1 including an instruction to release the brake binding and the mechanical brake device 30 to be targeted, the transmission controller 18 turns on the relay 45 connected to the mechanical brake device 30 to be targeted. When the relay 45 is turned on, the solenoid 38b included in the transmission mechanism 38 is fed with electric power. In other words, in response to a manipulation to release the brake binding by the operator, the relay 45 is turned on and electric power supply to the solenoid 38b included in the transmission mechanism 38 is started. The relay 45 is provided for each mechanical brake device 30. Each relay 45 electrically connects the corresponding mechanical brake device 30 and the release power supply 44 or electrically disconnects the corresponding mechanical brake device 30 from the release power supply 44.

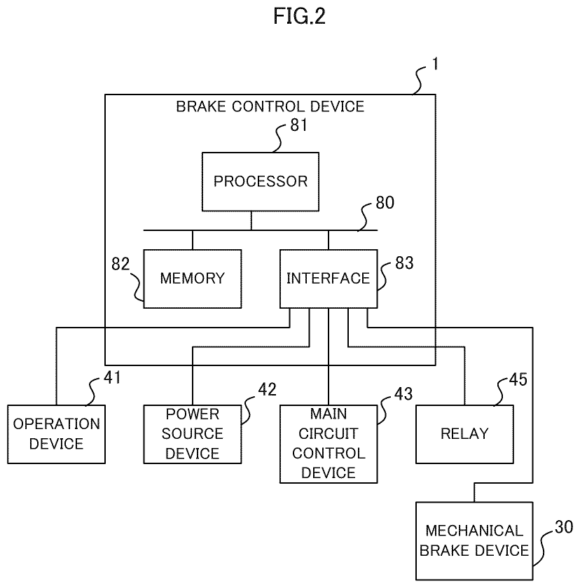

FIG. 2 illustrates a hardware configuration of the brake control device 1 having the above-described configuration. The brake control device 1 includes a processor 81, a memory 82, and an interface 83. The processor 81, the memory 82, and the interface 83 are connected to each other via buses 80. The functions of the components of the brake control device 1 are performed by software, firmware, or a combination of software and firmware. The software and firmware are described in the form of programs, and stored in the memory 82. The processor 81 reads and executes the programs stored in the memory 82, and thus achieves the above-described functions of the components. That is, the memory 82 stores programs for executing the processes of the components of the brake control device 1.

The memory 82 is, for example, a nonvolatile or volatile semiconductor memory such as a random-access memory (RAM), a read-only memory (ROM), a flash memory, an erasable programmable read only memory (EPROM), or an electrically erasable and programmable read only memory (EEPROM), or a magnetic disk, a flexible disk, an optical disc, a compact disc, a minidisc, or a digital versatile disc (DVD).

The brake control device 1 is connected to the operation device 41, the power source device 42, the main circuit control device 43, the relay 45 and the mechanical brake devices 30, via the interface 83. The interface 83 includes an interface module complying with one or more standards as appropriate for connection targets.

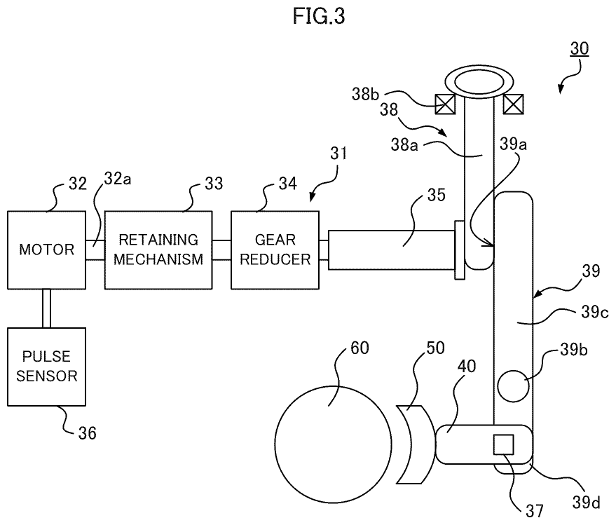

The mechanical brake device 30 illustrated in FIGS. 1 and 3 includes a pressing mechanism 31 driven by the electric power fed from the brake controller 13 of the brake control device 1 to press a force amplification mechanism 39, a transmission mechanism 38 that presses the force amplification mechanism 39 with a force of being pressed by the pressing mechanism 31 in a state in which the transmission mechanism 38 is in contact with the pressing mechanism 31 and the force amplification mechanism 39, and the force amplification mechanism 39 that urges a friction member 50 onto a rotating body 60 that rotates during running of the railway vehicle, in accordance with the force of being pressed by the pressing mechanism 31.

The pressing mechanism 31 includes the motor 32 driven by the electric power fed from the brake controller 13 to rotate a driving shaft 32a, a retaining mechanism 33 to transfer, to the output side, the rotation from the motor 32 connected to the input side, and a gear reducer 34 connected to the output side of the retaining mechanism 33 to output the reduced rotational speed. The pressing mechanism 31 also includes a rotary-to-linear conversion mechanism 35 connected to the driving shaft 32a of the motor 32 via the retaining mechanism 33 and the gear reducer 34. The rotary-to-linear conversion mechanism 35 slides its output shaft to urge the output shaft onto the force amplification mechanism 39 in accordance with the rotation of the driving shaft 32a.

The mechanical brake device 30 further includes the pulse sensor 36 that detects the rotational speed of the motor 32, and the load cell 37 that detects the pressing force, or the force of the force amplification mechanism 39 urging the friction member 50 onto the rotating body 60.

The following describes the components of the mechanical brake device 30 in detail. The motor 32 is driven to rotate by the three-phase AC power fed from the power conversion circuit 16. The rotation of the motor 32 is transferred to the retaining mechanism 33 via the driving shaft 32a.

The retaining mechanism 33 transfers the torque from the motor 32, to the gear reducer 34. The retaining mechanism 33 suppresses the transfer of the rotation of the gear reducer 34 to the motor 32.

The gear reducer 34 reduces the rotational speed of the motor 32, and transfers the torque of the motor 32 to the rotary-to-linear conversion mechanism 35.

The rotary-to-linear conversion mechanism 35 is coupled to the driving shaft 32a of the motor 32 via the retaining mechanism 33 and the gear reducer 34. In Embodiment 1, the mechanical brake device 30 is an active-type mechanical brake device. The output shaft of the rotary-to-linear conversion mechanism 35 moves toward the force amplification mechanism 39 in response to the forward rotation of the motor 32. The output shaft of the rotary-to-linear conversion mechanism 35 moves apart from the force amplification mechanism 39 in response to the reverse rotation of the motor 32.

The transmission mechanism 38 is at least partially formed of a magnetic material. In Embodiment 1, the transmission mechanism 38 includes a transmission member 38a formed of a rod-shaped magnetic material and having a ring-shaped handle at one end, and the solenoid 38b that moves the transmission member 38a by magnetic force generated when energized. With the transmission member 38a being in contact with both the output shaft of the rotary-to-linear conversion mechanism 35 included in the pressing mechanism 31 and the force amplification mechanism 39, when the motor 32 rotates in the forward direction to press the output shaft of the rotary-to-linear conversion mechanism 35, the transmission member 38a presses the force amplification mechanism 39 with the force applied by the output shaft.

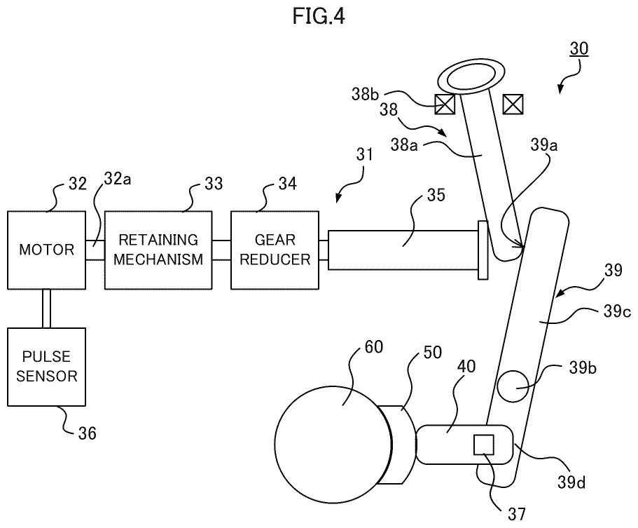

Specifically, as illustrated in FIG. 4, when the transmission member 38a is pressed by the output shaft, the transmission member 38a pivotally moves around one end where the ring-shaped handle, serving as a pivot point, is provided. As a result, the force amplification mechanism 39 pressed by the pivotally-moving transmission member 38a urges the friction member 50 onto the rotating body 60, thereby generating mechanical braking force.

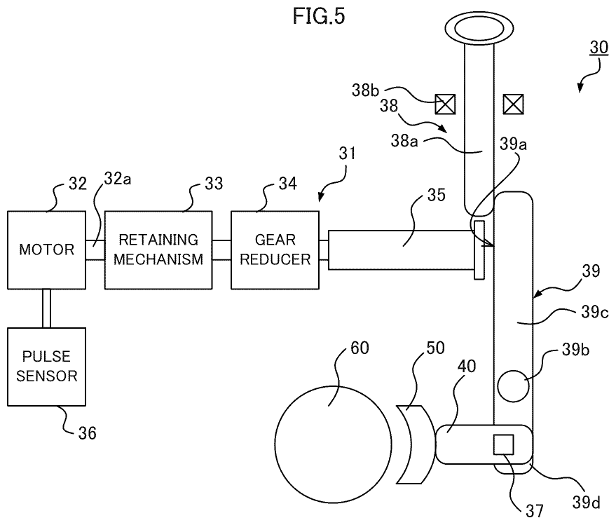

The solenoid 38b included in the transmission mechanism 38 allows or suppresses pressing of the force amplification mechanism 39 by the transmission member 38a with the force of pressing the transmission member 38a by the pressing mechanism 31. Specifically, when the solenoid 38b is fed with electric power in the state illustrated in FIG. 4, the solenoid 38b pulls the transmission mechanism 38 in a direction away from the output shaft of the rotary-to-linear conversion mechanism 35 included in the pressing mechanism 31 and the force amplification mechanism 39 by magnetic force. As a result, as illustrated in FIG. 5, the transmission member 38a is provided at a position away from the output shaft of the rotary-to-linear conversion mechanism 35 included in the pressing mechanism 31 and the force amplification mechanism 39. Thus, force is not transmitted from the pressing mechanism 31 to the force amplification mechanism 39, and the friction member 50 is provided at a position away from the rotating body 60, which results in generating no mechanical braking force. In other words, the brake binding is released.

The force amplification mechanism 39 urges the friction member 50 onto the rotating body 60 in accordance with the force of being pressed by the transmission mechanism 38 that pivotally moves in response to pressing by the output shaft of the rotary-to-linear conversion mechanism 35. In Embodiment 1, the force amplification mechanism 39 is a lever mechanism that amplifies the force applied to an effort point 39a from the transmission mechanism 38 and outputs the amplified force from a load point 39d. In detail, the force amplification mechanism 39 includes an arm 39c that can pivot around a fulcrum 39b. The load point 39d, located at the end opposite to the effort point 39a relative to the fulcrum 39b of the arm 39c, is provided with the friction member 50 via an attachment mechanism 40.

Examples of the friction member 50 include brake shoes and brake pads. Examples of the rotating body 60 include wheels and disc rotors. As illustrated in FIG. 4, when a force is applied to the effort point 39a of the force amplification mechanism 39, the arm 39c pivots around the fulcrum 39b. This pivot movement urges the friction member 50 attached to the load point 39d via the attachment mechanism 40 onto the rotating body 60, and thus generates a mechanical braking force, which results in obtaining braking force for braking the railway vehicle.

As described above, the output shaft of the rotary-to-linear conversion mechanism 35 is pressed onto the transmission mechanism 38 using the torque of the motor 32 and the transmission mechanism 38 presses the force amplification mechanism 39, then the friction member 50 is urged onto the rotating body 60. The torque of the motor 32 is determined from the force of urging the friction member 50 onto the rotating body 60, using parameters defined by a positional relationship among the effort point 39a, the fulcrum 39b, and the load point 39d of the force amplification mechanism 39, a ratio between the amount of rotational movement and the amount of linear movement in the rotary-to-linear conversion mechanism 35, a rate of reduction of the gear reducer 34, and other factors. The speed controller 14 of the brake controller 13 preliminarily retains these parameters in the form of parameters of the mechanical brake device 30.

The pulse sensor 36 is disposed in the vicinity of the motor 32 and detects the rotational speed of the motor 32. The pulse sensor 36 transmits the detected rotational speed of the motor 32 to the speed controller 14 of the brake controller 13.

The load cell 37 is provided to the force amplification mechanism 39. The load cell 37 measures the pressing force of the force amplification mechanism 39 urging the friction member 50 onto the rotating body 60, and transmits the measured pressing force to the target mechanical-braking force determiner 12 of the brake control device 1.

In the mechanical brake device 30 having the above configuration, when a failure of the motor 32 occurs or the friction member 50 and the rotating body 60 are stuck in the state illustrated in FIG. 4, the brake binding may occur in which the friction member 50 remains urged onto the rotating body 60 even in a case where the braking command B1 is not input to the brake control device 1. In response to a manipulation of the release machine to release the brake binding in the mechanical brake device 30 by the operator, the release command S1 including an instruction to release the brake binding and the mechanical brake device 30 to be targeted is input to the transmission controller 18 included in the brake control device 1.

When the transmission controller 18 acquires the release command S1, the transmission controller 18 turns on the relay 45 that connects the release power supply 44 and the solenoid 38b of the transmission mechanism 38 included in the mechanical brake device 30 to be targeted. As a result, the solenoid 38b is energized, and the transmission member 38a is provided at a position away, by the magnetic force due to the solenoid 38b, from the output shaft of the rotary-to-linear conversion mechanism 35 included in the pressing mechanism 31 and the force amplification mechanism 39. Thus, force is not transmitted from the pressing mechanism 31 to the force amplification mechanism 39, and the friction member 50 is provided at a position away from the rotating body 60, which results in generating no mechanical braking force. As a result, the brake binding in the mechanical brake devices 30 is released.

As described above, in response the brake control device 1 according to Embodiment 1 acquiring the release command S1, the brake control device 1 supplies the electric power to the solenoid 38b of the transmission mechanism 38 included in the mechanical brake device 30 to be targeted and moves, by the magnetic force, the transmission member 38a in a direction away from the output shaft of the rotary-to-linear conversion mechanism 35 included in the pressing mechanism 31 and the force amplification mechanism 39. As a result, pressing of the force amplification mechanism 39 by the transmission member 38a with the force applied from the pressing mechanism 31 is suppressed, and the brake binding in the mechanical brake device 30 to be targeted is released.

### Embodiment 2

The method of the brake control by the brake control device 1 is not limited to the above-described examples. The description of Embodiment 2 is directed to a brake control method by a brake control device 1 for achieving the target deceleration indicated by the braking command B1 in response to input of the release command S1, focusing on the differences from Embodiment 1. The target deceleration indicated by the braking command B1 is a target deceleration indicated by the normal braking command when the braking command B1 contains the normal braking command, an emergency deceleration indicated by the emergency braking command when the braking command B1 contains the emergency braking command, or a safety deceleration determined in accordance with the safety braking command when the braking command B1 contains the safety braking command.

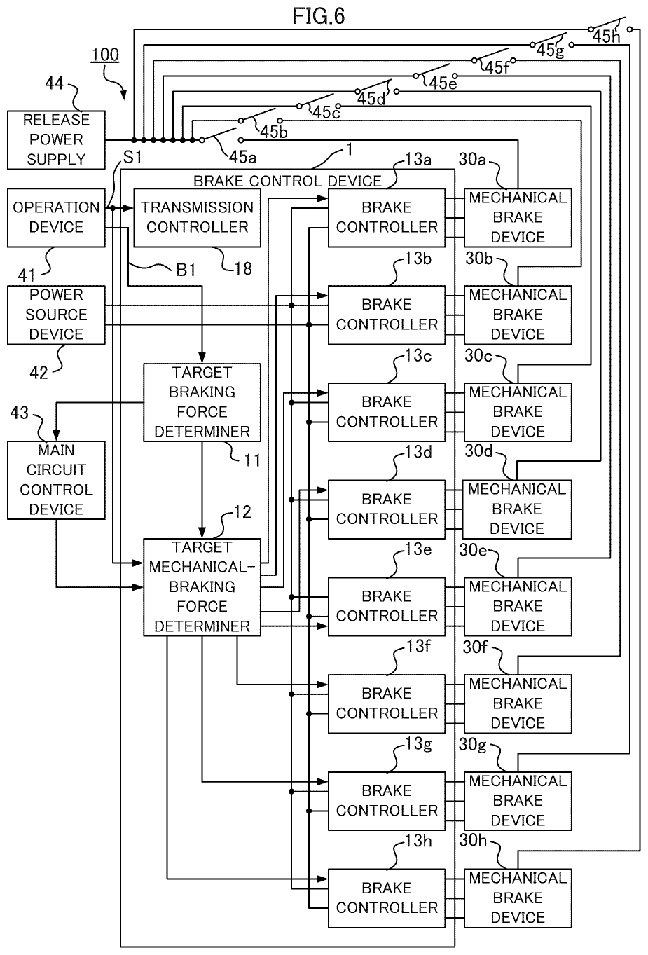

FIG. 6 illustrates a brake control device 1 according to Embodiment 2 having the configuration similar to that in Embodiment 1. FIG. 6 illustrates mechanical brake devices 30a, 30b, 30c, 30d, 30e, 30f, 30g, and 30h provided to the respective wheels. The mechanical brake devices 30a and 30b urge the friction members 50 onto the respective rotating bodies 60 that are mutually different wheels attached to the same axle. The mechanical brake devices 30c and 30d urge the friction members 50 onto the respective rotating bodies 60 that are mutually different wheels attached to the same axle. The mechanical brake devices 30e and 30f urge the friction members 50 onto the respective rotating bodies 60 that are mutually different wheels attached to the same axle. Also, the mechanical brake devices 30g and 30h urge the friction members 50 onto the respective rotating bodies 60 that are mutually different wheels attached to the same axle.

The mechanical brake devices 30a to 30h have the same configuration as the mechanical brake device 30 in Embodiment 1. FIG. 6 does not illustrate some arrows from the mechanical brake devices 30a to 30h to the target mechanical-braking force determiner 12, in order to simplify the figure.

In Embodiment 2, the brake control device 1 deems the wheels as the units for control in the brake control process. In other words, the brake control device 1 includes brake controllers 13a, 13b, 13c, 13d, 13e, 13f, 13g, and 13h that respectively control the mechanical brake devices 30a, 30b, 30c, 30d, 30e, 30f, 30g, and 30h.

Although FIG. 6 does not illustrate the configuration of the brake controllers 13a to 13h in order to simplify the figure, the brake controllers 13a to 13h have the same configuration as the brake controller 13 in Embodiment 1. The brake control device 1 according to Embodiment 2 includes a hardware configuration similar to that in Embodiment 1.

The relays 45a, 45b, 45c, 45d, 45e, 45f, 45g, and 45h are provided between the respective mechanical brake devices 30a, 30b, 30c, 30d, 30e, 30f, 30g, and 30h and the release power supply 44.

The relays 45a to 45h have the same configuration as the relay 45 according to Embodiment 1. FIG. 6 does not illustrate some arrows from the transmission controller 18 to the relays 45a to 45h, in order to simplify the figure.

The target mechanical-braking force determiner 12 determines target mechanical-braking forces of the respective mechanical brake devices 30a to 30h, as in Embodiment 1. When the target mechanical-braking force determiner 12 acquires, from the operation device 41, a release command S1 including an instruction to release the brake binding and a mechanical brake device to be targeted among the mechanical brake devices 30a to 30h, the target mechanical-braking force determiner 12 reallocates the target mechanical-braking force of the mechanical brake device to be targeted to other mechanical brake devices different from the mechanical brake device to be targeted. As a result, the target mechanical-braking forces of the other mechanical brake devices increase.

For example, adjustment of the target mechanical-braking force by the target mechanical-braking force determiner 12 is described using an example in which the mechanical brake device 30a is the target of releasing of brake binding indicated by the release command S1. The release command S1 that provides an instruction for release of brake binding in the mechanical brake device 30a is supplied to the transmission controller 18 and the target mechanical-braking force determiner 12. As in Embodiment 1, when the transmission controller 18 turns on the relay 45a, the solenoid 38b included in the transmission mechanism 38 of the mechanical brake device 30a is energized, and the transmission member 38a is separated from the pressing mechanism 31 and the force amplification mechanism 39. As a result, urging of the friction member 50 onto the rotating body 60 by the mechanical brake device 30a is suppressed, which results in generating no mechanical braking force by the mechanical brake device 30a. That is, the brake binding in the mechanical brake device 30a is released.

The target mechanical-braking force determiner 12 determines the target mechanical-braking forces of the respective mechanical brake devices 30a to 30h from the difference between the target braking force acquired from the target braking force determiner 11 and the actual electric braking force indicated by the regeneration feedback. The target mechanical-braking force determiner 12 reallocates the target mechanical-braking force of the mechanical brake device 30a that is the target of releasing of brake binding, to other mechanical brake devices, specifically, at least one of the mechanical brake devices 30b to 30h.

For example, the target mechanical-braking force determiner 12 reallocates the target mechanical-braking force of the mechanical brake device 30a equally to the mechanical brake devices 30c to 30h, excluding the mechanical brake device 30b corresponding to a wheel attached to the same axle as the wheel corresponding to the mechanical brake device 30a. In other words, the target mechanical-braking force determiner 12 divides the target mechanical-braking force of the mechanical brake device 30a into six equal parts to obtain the compensation amount, and adds the compensation amount to the target mechanical-braking forces of the respective mechanical brake devices 30c to 30h. As a result, the target mechanical-braking force of the mechanical brake device 30a is allocated to the mechanical brake devices 30c to 30h, and the target mechanical-braking forces of the mechanical brake devices 30c to 30h increase.

The target mechanical-braking force determiner 12 transmits the target mechanical-braking force of the mechanical brake device 30b, determined from the target braking force and the actual electric braking force as described above, to the brake controller 13b. The target mechanical-braking force determiner 12 transmits the adjusted target mechanical-braking forces of the mechanical brake devices 30c to 30h to the respective brake controllers 13c to 13h. As a result, even when mechanical braking force is not generated by the mechanical brake device 30a as described above, mechanical braking forces by the mechanical brake devices 30c to 30h increase, making it possible to achieve the target deceleration indicated by the braking command B1.

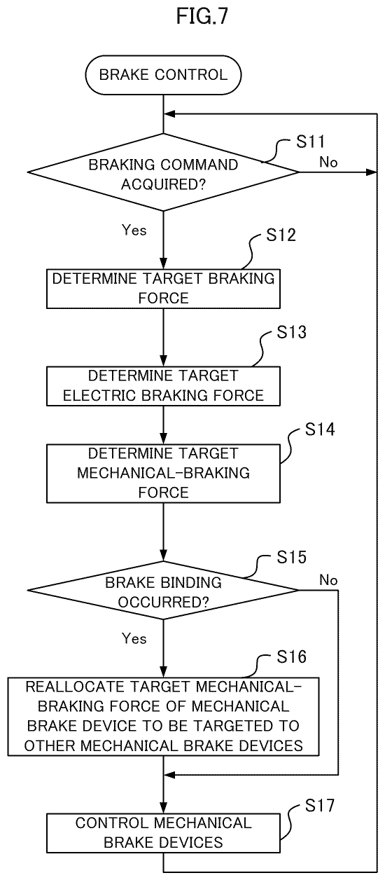

The following describes a brake control process performed by the brake control device 1 having the above-described configuration, with reference to FIG. 7. The brake control device 1 initiates the process illustrated in FIG. 7 at the start of traveling of the railway vehicle. Specifically, the brake control device 1 initiates the process illustrated in FIG. 7 when an ascending switch is manipulated to bring pantographs, which are examples of the current collector, into contact with an overhead wire, which is an example of the power supply line.

In the absence of the braking command B1 from the operation device 41 (Step S11; No), the target braking force determiner 11 repeats the process in Step S11.

When acquiring the braking command B1 from the operation device 41 (Step S11; Yes), the target braking force determiner 11 determines a target braking force from the braking command B1 (Step S12).

The target braking force determiner 11 determines a target electric braking force from the target braking force (Step S13). The target braking force determiner 11 transmits the determined target electric braking force to the main circuit control device 43.

The target mechanical-braking force determiner 12 then determines a target mechanical-braking force from the difference between the target braking force determined in Step S12 and the actual electric braking force (Step S14). The target mechanical-braking force determiner 12 determines whether the brake binding occurs (step S15). In Embodiment 2, the target mechanical-braking force determiner 12 determines, based on whether the release command S1 that provides an instruction for release of brake binding is acquired, whether the brake binding occurs. When the brake binding occurs, that is, when the release command S1 is acquired (Step S15; Yes), the target mechanical-braking force determiner 12 reallocates the target mechanical-braking force of the mechanical brake device that is the target of releasing of brake binding indicated by the release command S1, among the mechanical brake devices 30a to 30h, to other mechanical brake devices (Step S16).

When the target mechanical-braking force determiner 12 does not acquire the release command S1 (Step S15; No), the process in Step S16 is not performed.

The brake controllers 13a to 13h control the respective mechanical brake devices 30a to 30h in accordance with the target mechanical-braking force determined in Step S14 or the target mechanical-braking force determined in Step S16 (Step S17). After Step S17, the brake control device 1 returns to Step S11 and re-performs the above-described steps. The brake control device 1 repeats the above-described process illustrated in FIG. 7 at predetermined intervals during travelling of the railway vehicle.

As described above, the brake control device 1 according to Embodiment 2 reallocates the target mechanical-braking force of the mechanical brake device that is the target of releasing of brake binding indicated by the release command S1, among the mechanical brake devices 30a to 30h, to other mechanical brake devices. As a result, even when mechanical braking force is not generated by the mechanical brake device that is the target of releasing of brake binding, mechanical braking forces by other mechanical brake devices increase, and the target deceleration indicated by the braking command B1 is obtained.

### Embodiment 3

The method of the brake control by the brake control device 1 is not limited to the above-described examples. The description of Embodiment 3 is directed to a brake control method by a brake control device 1 for achieving the safety deceleration in accordance with the safety braking command in response to input of the braking command B1 containing the safety braking command and the release command S1, focusing on the differences from Embodiments 1 and 2.

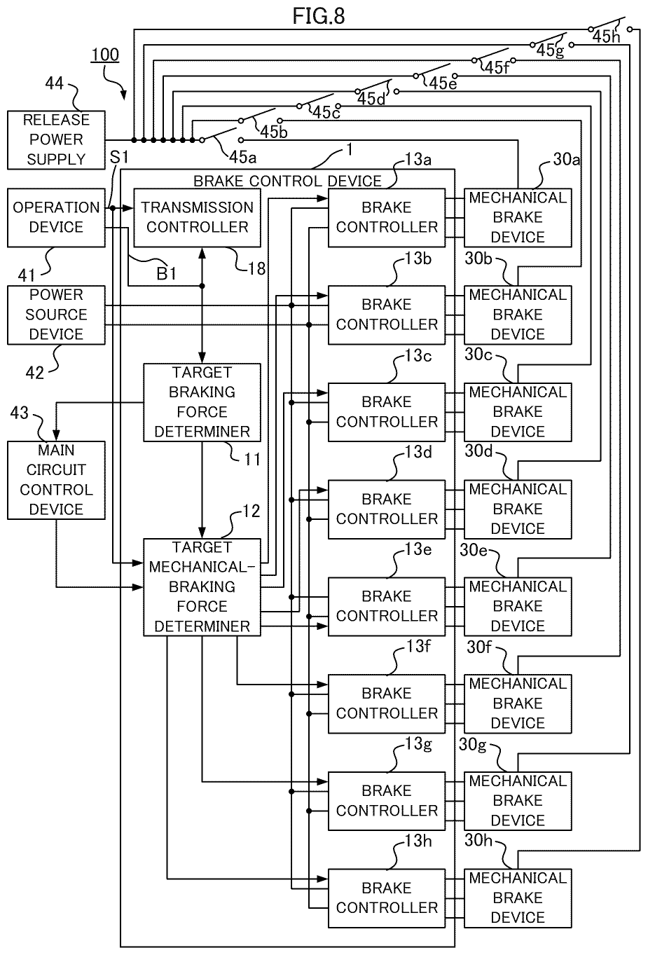

A configuration of the brake control device 1 according to Embodiment 3 illustrated in FIG. 8 is similar to that of Embodiment 2 except that the transmission controller 18 acquires the braking command B1. The brake control device 1 according to Embodiment 3 includes a hardware configuration similar to that in Embodiment 1.

When the transmission controller 18 acquires the braking command B1 containing the safety braking command, the transmission controller 18 maintains the relays 45a to 45h in the off state regardless of the release command S1. Therefore, even when the release command S1 is input, the transmission mechanisms 38 of the mechanical brake devices 30a to 30h press the force amplification mechanisms 39 with the force applied from the pressing mechanisms 31. As a result, the force amplification mechanisms 39 of the mechanical brake devices 30a to 30h urge the friction members 50 onto the rotating bodies 60, thereby generating mechanical braking forces. In other words, when the braking command B1 containing the safety braking command is input, releasing of brake binding is not performed in the mechanical brake devices 30a to 30h even when the release command S1 is input.

As described above, when the brake control device 1 according to Embodiment 3 acquires the braking command B1 containing the safety braking command, the brake control device 1 maintains the relays 45a to 45h in the off state even when the release command S1 is acquired. As a result, when the safety braking command is input, mechanical braking forces are generated by the mechanical brake devices 30a to 30h even when the brake binding has occurred, and the safety deceleration indicated by the safety braking command is obtained.

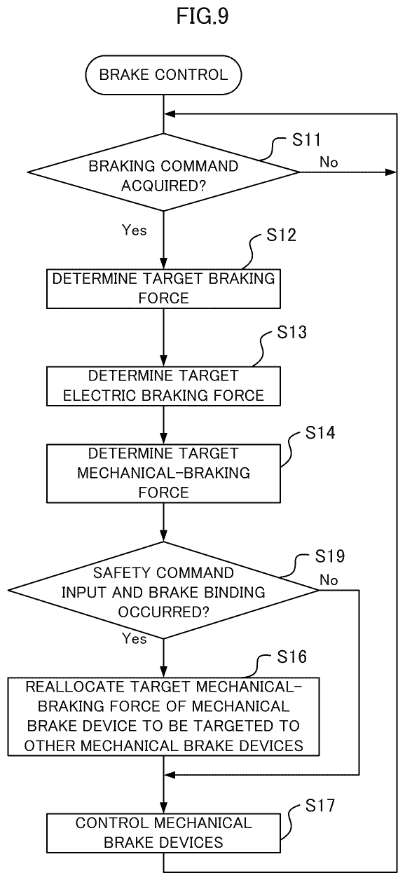

The above-described embodiments are not to be construed as limiting the scope of the present disclosure. As one example, the brake control device 1 according to Embodiment 2 may reallocate the target mechanical-braking force of the mechanical brake device to be targeted, to other mechanical brake devices when the braking command B1 containing the safety braking command that requires reliable stopping of the railway vehicle and the release command S1 are input, as illustrated in FIG. 9.

Steps S11 to S14, S16, and S17 in FIG. 9 are similar to the processes of Steps S11 to S14, S16, and S17 illustrated in FIG. 7. The target mechanical-braking force determiner 12 determines whether the safety braking command is input and the brake binding occurs (step S19). When the braking command B1 contains the safety braking command and the brake binding occurs, that is, when the release command S1 is acquired (Step S19; Yes), the target mechanical-braking force determiner 12 reallocates the target mechanical-braking force of the mechanical brake device that is the target of releasing of brake binding indicated by the release command S1, among the mechanical brake devices 30a to 30h, to other mechanical brake devices (Step S16). When the safety braking command is not contained in the braking command B1 acquired by the target mechanical-braking force determiner 12 or the target mechanical-braking force determiner 12 does not acquire the release command S1 (Step S19; No), the process in Step S16 is not performed. As described above, by reallocating the target mechanical-braking force of the mechanical brake device that is the target of releasing of brake binding indicated by the release command S1 to other mechanical brake devices, the safety deceleration indicated by the safety braking command is obtained.

As another example, the target mechanical-braking force determiner 12 may perform the process of Step S16 when the braking command B1 contains the emergency braking command or the safety braking command and the release command S1 is acquired.

For a railway vehicle that decelerates using only a mechanical braking force without an electric braking force, the target mechanical-braking force determiner 12 determines target mechanical-braking forces of the mechanical brake devices 30a to 30h from the target braking force determined by the target braking force determiner 11.

The brake control device 1 may control the mechanical brake device 30 in each unit for control, such as each axle, each bogie, or each vehicle body, as well as each wheel. The brake controller 13 is provided for each unit for control, that is, for each wheel, each axle, each bogie, or each vehicle body. In an exemplary case of control of the mechanical brake devices 30a to 30h for each axle, the motors 32 included in the mechanical brake devices 30a and 30b are fed with the same electric power. The motors 32 included in the mechanical brake devices 30c and 30d are fed with the same electric power. The motors 32 included in the mechanical brake devices 30e and 30f are fed with the same electric power. Also, the motors 32 included in the mechanical brake devices 30g and 30h are fed with the same electric power.

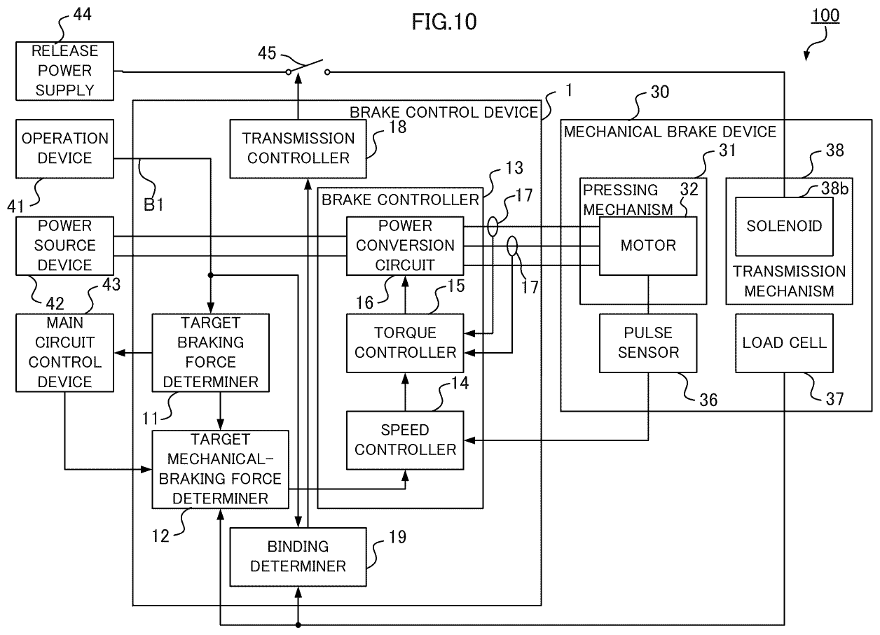

The brake control device 1 may determine whether the brake binding occurs and control the transmission mechanisms 38 of the mechanical brake devices 30 in accordance with the determination result. The brake control device 1 illustrated in FIG. 10 includes a binding determiner 19 that determines whether the brake binding occurs based on the braking command B1 and measurement value of the load cell 37.

In a state in which the braking command B1 is not acquired from the operation device 41, when the value acquired from the load cell 37 of the mechanical brake device 30 is equal to or greater than a threshold value, the binding determiner 19 determines that the brake binding occurs in the mechanical brake device. The threshold value may be set to a sufficiently small value that can be regarded as zero, such as a value of pressing force of the mechanical brake device 30 that may occur in a state in which the braking command B1 is not input.

A method to be performed by the binding determiner 19 to determine whether the brake binding occurs is not limited to the above examples, and any method may be used as long as occurrence of brake binding can be detected. As one example, in a state in which when an operation command acquired from the operation device 41 contains a powering command, when acceleration of the railway vehicle is not within an allowable range of which a center value is a target acceleration indicated by the powering command, the binding determiner 19 may determine that the brake binding occurs. The allowable range is, for example, a numerical range defined using a coefficient c1 that is a positive number less than 1, where the lower limit is the result of multiplying the target acceleration by (1−c1), and the upper limit is the result of multiplying the target acceleration by (1+c1). For example, c1 may be 0.2.

The brake control device 1 may acquire the braking command by a procedure other than that in the above-described examples. As one example, the target braking force determiner 11 may acquire the braking command B1 containing the normal braking command via a train information management system. For another example, the target braking force determiner 11 may acquire a braking command B1 containing an emergency braking command from an automatic train stop (ATS) apparatus. Alternatively, the target braking force determiner 11 may acquire a safety braking command from a safety brake controller that outputs the safety braking command at the H level when the deceleration of the railway vehicle is lower than a threshold despite of input of the normal braking command or the emergency braking command.

The mechanical brake devices 30a to 30h are not necessarily the electrically operated mechanical brake devices. For example, each of the mechanical brake devices 30a to 30h may include a pressing mechanism 31 of which the output shaft is displaced in accordance with the pressure of a fluid, such as air or oil. In this case, the brake control device 1 shifts the position of the output shaft by varying the pressure of the fluid fed to the pressing mechanism 31, and thus controls the mechanical brake devices 30.

The mechanical brake devices 30 are not limited to active type mechanical brake devices and may be passive type or semi-active type mechanical brake devices. A passive type mechanical brake device 30 includes an urging member that urges the transmission mechanism 38 to the force amplification mechanism 39 with a constant force. The passive type mechanical brake device 30 is capable of adjusting the mechanical braking force by applying, to the urging member, a force in a direction opposite to an urging direction by the output shaft of the rotary-to-linear conversion mechanism 35 that slides in accordance with rotation of the motor 32.

A semi-active type mechanical brake device 30 is capable of adjusting the mechanical braking force by applying, to the urging member, a force either in the opposite direction or in the same direction in accordance with the strength of braking.

The braking command B1 may contain a parking braking command. When the brake control device 1 acquires, for example, the braking command B1 containing the parking braking command, the brake control device 1 maintains the relays 45a to 45h in the off state regardless of the release command S1 as in Embodiment 3.

A structure of the transmission mechanism 38 is not limited to the above examples and may be any structure as long as the transmission mechanism 38 is capable of pressing the force amplification mechanism 39 with a force applied from the pressing mechanism 31 in a state in which the transmission mechanism 38 is in contact with the pressing mechanism 31 and the force amplification mechanism 39, and is capable of moving to a position away from at least any of the pressing mechanism 31 and the force amplification mechanism 39 for release of the brake binding. As one example, the transmission member 38a included in the transmission mechanism 38 may have a flat-plate shape. As another example, the transmission member 38a may have a structure that allows movement to a position away from at least any of the pressing mechanism 31 and the force amplification mechanism 39 by pivotally moving around one end, of the transmission member 38a, where the ring-shaped handle is provided.

As another example, the transmission member 38a may have a structure that allows movement to a position away from at least any of the pressing mechanism 31 and the force amplification mechanism 39 by rotating about as a rotational axis that extend in an extension direction.

In the above embodiments, the transmission member 38a is moved by magnetic force of the solenoid 38b. However, the transmission member 38a may be moved to a position away from at least any of the pressing mechanism 31 and the force amplification mechanism 39 by a worker pulling the ring-shaped handle of the transmission member 38a.

The mechanical brake device 30 may have a configuration other than that in the above-described examples. For example, the force amplification mechanism 39 is not necessarily a lever mechanism and may also be a toggle mechanism or a linkage mechanism. For another example, the mechanical brake device 30 may lack the load cell 37. In the case of no load cell 37, the speed controller 14 of the brake controller 13 may perform feedback control based on the speed of the railway vehicle, for example.

As another example, the mechanical brake device 30 may further include an urging member that urges the friction member 50 in a direction away from the rotating body 60. The urging member may have a spring constant large enough to separate the friction member 50 from the rotating body 60 in a state in which the force amplification mechanism 39 does not press the friction member 50 toward the rotating body 60. By providing the urging member, when pressing of the force amplification mechanism 39 by the transmission mechanism 38 is suppressed, the friction member 50 can immediately separate from the rotating body 60, thereby releasing the brake binding.

The central part that includes the processor 81, the memory 82, and the interface 83 and executes the control process can be achieved by not only dedicated systems but also ordinary computer systems. For example, a computer program for executing the above-described operation may be stored in non-transitory computer-readable recording mediums, such as flexible disks, compact disc read-only memories (CD-ROMs), and digital versatile disc read-only memories (DVD-ROMs), and distributed. The computer program may then be installed in a computer, so as to configure the brake control device 1 for performing the operations. Alternatively, the computer program may be stored in a storage included in a server on a communication network, and may be downloaded into an ordinary computer system to configure the brake control device 1.

In the case where the functions of the brake control device 1 are achieved by sharing of an operating system (OS) and an application program or by cooperation of the OS and the application program, only the application program may be stored in a non-transitory recording medium or a storage device, for example.

The computer program may be distributed via a communication network in the form of being superimposed on carrier waves. For example, the computer program may be posted on a bulletin board system (BBS) on a communication network and may be distributed to computers via the communication network. The computers may activate this computer program and execute the computer program under the control of the OS in a manner similar to the other application programs, and thereby execute the above-described processes.

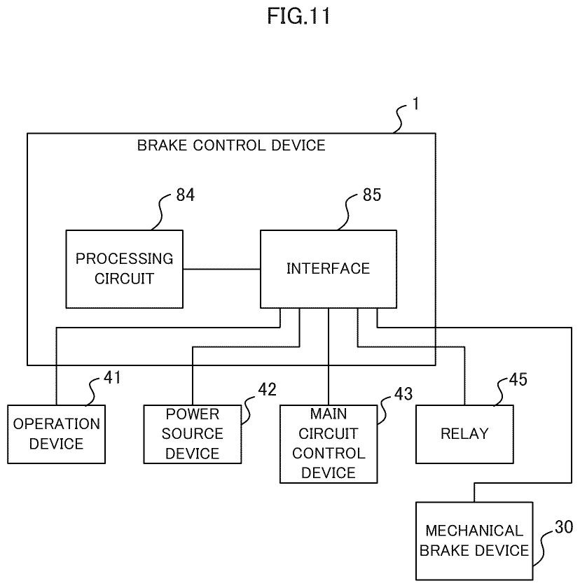

The brake control device 1 may be achieved by a processing circuit 84, as illustrated in FIG. 11. The processing circuit 84 is connected to the operation device 41, the power source device 42, the main circuit control device 43, the relay 45, and the mechanical brake devices 30, via an interface circuit 85. In the case where the processing circuit 84 is dedicated hardware, the processing circuit 84 includes a single circuit, a combined circuit, a programmed processor, a parallel programmed processor, an application specific integrated circuit (ASIC), a field programmable gate array (FPGA), or a combination thereof, for example. The individual components of the brake control device 1 may be implemented by separate processing circuits 84 or by the common processing circuit 84.

A part of the functions of the brake control device 1 may be achieved by dedicated hardware, whereas another part of the functions may be achieved by software or firmware. For example, the target braking force determiner 11 and the transmission controller 18 of the brake control device 1 may be implemented by the processing circuit 84 illustrated in FIG. 11, whereas the target mechanical-braking force determiner 12 and the brake controller 13 of the brake control device 1 may be implemented by the programs stored in the memory 82 when the programs are read and executed by the processor 81 illustrated in FIG. 2.

The foregoing describes some example embodiments for explanatory purposes. Although the foregoing discussion has presented specific embodiments, persons skilled in the art will recognize that changes may be made in form and detail without departing from £ the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Brake control device
11 Target braking force determiner
12 Target mechanical-braking force determiner
13, 13a, 13b, 13c, 13d, 13e, 13f, 13g, 13h Brake controller
14 Speed controller
15 Torque controller
16 Power conversion circuit
17 Current sensor
18 Transmission controller
19 Binding determiner
30, 30a, 30b, 30c, 30d, 30e, 30f, 30g, 30h Mechanical brake device
31 Pressing mechanism
32 Motor
32a Driving shaft
33 Retaining mechanism
34 Gear reducer
35 Rotary-to-linear conversion mechanism
36 Pulse sensor
37 Load cell
38 Transmission mechanism
38a Transmission member
38b Solenoid
39 Force amplification mechanism
39a Effort point
39b Fulcrum
39c Arm
39d Load point
40 Attachment mechanism
41 Operation device
42 Power source device
43 Main circuit control device
44 Release power supply
45, 45a, 45b, 45c, 45d, 45e, 45f, 45g, 45h Relay
50 Friction member
60 Rotating body
80 Bus
81 Processor
82 Memory
83 Interface
84 Processing circuit
85 Interface circuit
100 Brake control system
B1 Braking command
S1 Release command

1. A brake control device that controls mechanical brake devices each including a force amplification mechanism that generates a braking force by urging, in accordance with a force of being pressed, a friction member onto a rotating body that rotates during running of a railway vehicle, a pressing mechanism that presses the force amplification mechanism, and a transmission mechanism that is provided between the pressing mechanism and the force amplification mechanism and presses the force amplification mechanism with a force pressed by the pressing mechanism in a state in which the transmission mechanism is in contact with the pressing mechanism and the force amplification mechanism, the brake control device comprising:
target braking force determining circuitry to determine a target braking force from a braking command that provides an instruction for deceleration of the railway vehicle;
target mechanical-braking force determining circuitry to determine target mechanical-braking forces from the target braking force, the target mechanical-braking forces being each a target value of the braking force to be generated by the mechanical brake device;
brake controlling circuitry to control the pressing mechanisms in accordance with the target mechanical-braking forces; and
transmission controlling circuitry to allow or suppress pressing of the force amplification mechanisms by the transmission mechanisms.

2. The brake control device according to claim 1, wherein
the transmission controlling circuitry
allows the pressing of the force amplification mechanism by the transmission mechanism until acquiring a release command that provides an instruction for release of brake binding occurred in at least one of the mechanical brake devices, and
suppresses the pressing of the force amplification mechanism by the transmission mechanism included in the at least one of the mechanical brake devices that is a target of the release command upon acquiring the release command.

3. The brake control device according to claim 1, further comprising:
binding determining circuitry to determine whether the brake binding occurs in the mechanical brake devices, wherein
the transmission controlling circuitry
allows the pressing of the force amplification mechanism by the transmission mechanism included in a first mechanical brake device, of the mechanical brake devices, determined by the binding determining circuitry as not experiencing the brake binding, and
suppresses the pressing of the force amplification mechanism by the transmission mechanism included in a second mechanical brake device, of the mechanical brake devices, determined by the binding determining circuitry as experiencing the brake binding.

4. The brake control device according claim 1, wherein
the transmission controlling circuitry
stops supply of electric power to a solenoid included in the transmission mechanism to allow the pressing of the force amplification mechanism by a transmission member that is included in the transmission mechanism and is at least partially formed of a magnetic material, and
supplies the electric power to the solenoid to suppress the pressing of the force amplification mechanism by the transmission member, the solenoid moving the transmission member in a direction away from at least any of the pressing mechanism and the force amplification mechanism by a magnetic force generated when energized.

5.-10. (canceled)

11. The brake control device according to claim 2, wherein
the transmission controlling circuitry
stops supply of electric power to a solenoid included in the transmission mechanism to allow the pressing of the force amplification mechanism by a transmission member that is included in the transmission mechanism and is at least partially formed of a magnetic material, and
supplies the electric power to the solenoid to suppress the pressing of the force amplification mechanism by the transmission member, the solenoid moving the transmission member in a direction away from at least any of the pressing mechanism and the force amplification mechanism by a magnetic force generated when energized.

12. The brake control device according to claim 3, wherein
the transmission controlling circuitry
stops supply of electric power to a solenoid included in the transmission mechanism to allow the pressing of the force amplification mechanism by a transmission member that is included in the transmission mechanism and is at least partially formed of a magnetic material, and
supplies the electric power to the solenoid to suppress the pressing of the force amplification mechanism by the transmission member, the solenoid moving the transmission member in a direction away from at least any of the pressing mechanism and the force amplification mechanism by a magnetic force generated when energized.

13. The brake control device according to claim 1, wherein
the braking command contains at least any of a normal braking command, an emergency braking command, and a safety braking command, and
the transmission controlling circuitry allows the pressing of the force amplification mechanism by the transmission mechanism when the braking command contains the safety braking command.

14. The brake control device according to claim 2, wherein
the braking command contains at least any of a normal braking command, an emergency braking command, and a safety braking command, and
the transmission controlling circuitry allows the pressing of the force amplification mechanism by the transmission mechanism when the braking command contains the safety braking command.

15. The brake control device according to claim 3, wherein
the braking command contains at least any of a normal braking command, an emergency braking command, and a safety braking command, and
the transmission controlling circuitry allows the pressing of the force amplification mechanism by the transmission mechanism when the braking command contains the safety braking command.

16. The brake control device according to claim 1, wherein
when the brake binding occurs in at least one mechanical brake device of the mechanical brake devices, the target mechanical-braking force determining circuitry reallocates the target mechanical-braking force of the at least one mechanical brake device experiencing the brake binding to other mechanical brake devices that are mechanical brake devices other than the at least one mechanical brake device among the mechanical brake devices, to increase the target mechanical-braking forces of the other mechanical brake devices.

17. The brake control device according to claim 2, wherein
when the brake binding occurs in at least one mechanical brake device of the mechanical brake devices, the target mechanical-braking force determining circuitry reallocates the target mechanical-braking force of the at least one mechanical brake device experiencing the brake binding to other mechanical brake devices that are mechanical brake devices other than the at least one mechanical brake device among the mechanical brake devices, to increase the target mechanical-braking forces of the other mechanical brake devices.

18. The brake control device according to claim 3, wherein
when the brake binding occurs in at least one mechanical brake device of the mechanical brake devices, the target mechanical-braking force determining circuitry reallocates the target mechanical-braking force of the at least one mechanical brake device experiencing the brake binding to other mechanical brake devices that are mechanical brake devices other than the at least one mechanical brake device among the mechanical brake devices, to increase the target mechanical-braking forces of the other mechanical brake devices.

19. The brake control device according to claim 16, wherein
the braking command contains at least any of a normal braking command, an emergency braking command, and a safety braking command, and
when the braking command is the safety braking command and the brake binding occurs in at least one mechanical brake device of the mechanical brake devices, the target mechanical-braking force determining circuitry reallocates the target mechanical-braking force of the at least one mechanical brake device experiencing the brake binding to other mechanical brake devices that are mechanical brake devices other than the at least one mechanical brake device among the mechanical brake devices, to increase the target mechanical-braking forces of the other mechanical brake devices.

20. The brake control device according to claim 17, wherein
the braking command contains at least any of a normal braking command, an emergency braking command, and a safety braking command, and
when the braking command is the safety braking command and the brake binding occurs in at least one mechanical brake device of the mechanical brake devices, the target mechanical-braking force determining circuitry reallocates the target mechanical-braking force of the at least one mechanical brake device experiencing the brake binding to other mechanical brake devices that are mechanical brake devices other than the at least one mechanical brake device among the mechanical brake devices, to increase the target mechanical-braking forces of the other mechanical brake devices.

21. The brake control device according to claim 18, wherein
the braking command contains at least any of a normal braking command, an emergency braking command, and a safety braking command, and
when the braking command is the safety braking command and the brake binding occurs in at least one mechanical brake device of the mechanical brake devices, the target mechanical-braking force determining circuitry reallocates the target mechanical-braking force of the at least one mechanical brake device experiencing the brake binding to other mechanical brake devices that are mechanical brake devices other than the at least one mechanical brake device among the mechanical brake devices, to increase the target mechanical-braking forces of the other mechanical brake devices.

22. A mechanical brake device, comprising:
a force amplification mechanism to generate a braking force by urging, in accordance with a force of being pressed, a friction member onto a rotating body that rotates during running of a railway vehicle;
a pressing mechanism to press the force amplification mechanism; and
a transmission mechanism provided between the pressing mechanism and the force amplification mechanism, the transmission mechanism pressing the force amplification mechanism with a force pressed by the pressing mechanism in a state in which the transmission mechanism is in contact with the pressing mechanism and the force amplification mechanism and suppressing transmission of force from the pressing mechanism to the force amplification mechanism in a state in which the transmission mechanism is away from at least any of the pressing mechanism and the force amplification mechanism.

23. The mechanical brake device according to claim 22, wherein
the transmission mechanism includes
a transmission member at least partially formed of a magnetic material, and
a solenoid to move the transmission member in a direction away from at least any of the pressing mechanism and the force amplification mechanism by a magnetic force generated when energized.

24. A brake control system, comprising:
the mechanical brake device including
a force amplification mechanism to generate a braking force by urging, in accordance with a force of being pressed, a friction member onto a rotating body that rotates during running of a railway vehicle,
a pressing mechanism to press the force amplification mechanism, and
a transmission mechanism provided between the pressing mechanism and the force amplification mechanism, the transmission mechanism pressing the force amplification mechanism with a force pressed by the pressing mechanism in a state in which the transmission mechanism is in contact with the pressing mechanism and the force amplification mechanism and suppressing transmission of force the pressing mechanism to the force amplification mechanism in a state in which the transmission mechanism is away from at least any of the pressing mechanism and the force amplification mechanism, and
the brake control device according to claim 1.
